(19) United States
(12) Patent Application Publication
(10) Pub. No.: US 2009/0048899 A1
(43) Pub. Date: Feb. 19, 2009

(54) Method and System for Managing Construction Projects

(76) Inventor: Cody Bender, Fort Collins, CO (US)

Correspondence Address: HOLME ROBERTS & OWEN, LLP, 299 SOUTH MAIN, SUITE 1800, SALT LAKE CITY, UT, 84111, US

(21) Appl. No.: 12/191,117

(22) Filed: Aug. 13, 2008

Related U.S. Application Data
(60) Provisional application No. 60/955,457, filed on Aug. 13, 2007.

(51) Int. Cl. G06Q 10/00

(52) U.S. Cl. 705/9; 705/7

(57) ABSTRACT

A method for construction project management includes providing a plurality of standard inspection lists that is suitable for use across multiple construction projects. At least one standard inspection list includes at least one inspection. The method tracks inspections associated with a spatial division in a construction project, wherein at least one room in the spatial division is associated with a corresponding standard inspection list.

### CROSS REFERENCE TO RELATED APPLICATIONS

The present application claims priority to and the benefit of Provisional Application No. 60/955,457 to Cody Bender, entitled “Method and System for Managing Construction Projects,” filed Aug. 13, 2007, which is herein incorporated by reference in its entirety.

### BACKGROUND OF THE INVENTION

1. Field of Invention

The present invention relates to the field of construction projects. Specifically, the present invention relates to the automated process of performing tracking of inspections associated with a particular construction project.

2. The Relevant Technology

Construction projects are associated with permits and inspections. The permit process provides government authorization to build a specific structure, for example, within certain private and government (e.g., city, county, state, federal, etc.) guidelines. The inspections related to a construction project ensure that the structure complies with these guidelines. For example, inspections are required to ensure that the structure in relation to a particular permit is within applicable building codes.

The tracking of inspections is desirable for a particular construction project, since overall approval of the construction project is dependent on passing all associated inspections. Also, additional actions need to be taken and successfully completed before a failed inspection passes. Tracking is necessary to ensure these additional actions are completed before the failed inspections ultimately pass.

Traditional methods for tracking inspections for a given construction project are suitable for tracking uni-dimensional projects. These uni-dimensional construction projects are typically of a small scale. The inspections can be accomplished at a single time, usually at the end of the project. Each inspection associated with a small scale project is performed on the entire structure, and is performed according to a building schedule, which is quite linear and predictable. That is, the inspections are tied to the entire project and usually accomplished when the entire project has been completed. As such, traditional methods for tracking inspections for small-scale, uni-dimensional construction projects include various paper based systems, such as sticky notes, or scraps of paper that are tacked onto a wall within easy viewing. In addition, spreadsheets and other software applications that basically list the inspections and provide indications whether inspections have been completed for a particular construction project has been used for tracking inspections.

However, each of these traditional techniques lack the sophistication or complexity to track inspections for large scale construction projects, such as hotels, hospitals, office buildings, malls, etc. These large scale construction projects typically include multiple phases, areas, buildings, floors, rooms, etc. Also, many contractors are working on the construction project, thereby generating the need for performing inspections at different times. For instance, inspections are typically accomplished by room or area, with a greater level of detail needed to determine progress on the construction project. As such, inspections can occur at any point during the building of the construction project. In addition, inspections may be conditioned on the satisfactory completion of another inspection.

As such, the role of inspections in large scale construction projects are of greater complexity when compared to small scale construction projects. For instance, traditional techniques for construction management are inadequate for tracking inspections in these large scale construction projects. In addition, these traditional techniques lack the sophistication needed to accurately track and report on the process of inspections for large scale construction projects. Further, traditional techniques do not provide reliable data collection for inspections on larger scale construction projects, which results in increased risk of data loss.

### SUMMARY OF THE INVENTION

A method for construction project management includes providing a plurality of standard inspection lists that is suitable for use across multiple construction projects. At least one standard inspection list includes at least one inspection. The method tracks inspections associated with a spatial division in a construction project. At least one room in the spatial division is associated with a corresponding standard inspection list.

In another embodiment, a method for construction management is disclosed for purposes of managing the inspections associated with a construction project. In particular, at least one spatial division for a construction project is defined. At least one room is assigned to a defined spatial division. For each assigned room in the defined spatial division, an inspection list is assigned from a plurality of standard inspection lists. Inspections in the defined spatial division are tracked.

In still another embodiment, a system managing construction projects is disclosed. The system includes an inspection list generator for providing a plurality of standard inspection lists suitable for use across multiple construction projects. At least one standard inspection list comprises at least one inspection. A tracker is included which tracks inspections associated with a spatial division in a construction project. At least one room in the spatial division is associated with a corresponding standard inspection list.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of the hierarchy of multiple construction projects utilized in a system and method for inspection tracking, in accordance with one embodiment of the present invention.

FIG. 2 is an illustration of the relationship between room types and standard inspection lists, in accordance with one embodiment of the present invention.

FIG. 3 is a block diagram of a system for construction management capable of tracking inspections, in accordance with one embodiment of the present invention.

FIG. 4 is a flow diagram illustrating a platform implementing a method suitable for inspection tracking across multiple construction projects, in accordance with one embodiment of the present invention.

FIG. 5A is an exemplary user interface for listing and editing of standard inspection lists implemented in systems and methods for construction management, in accordance with one embodiment of the present invention.

FIG. 5B is an exemplary user interface for listing and editing inspections in a standard inspection list implemented in systems and methods for construction management, in accordance with one embodiment of the present invention.

FIG. 6 is a flow diagram illustrating a method for tracking inspections in a construction project, in accordance with one embodiment of the present invention.

FIG. 7 is an exemplary user interface for establishing spatial divisions for a construction project, in accordance with one embodiment of the present invention.

FIG. 8 is an exemplary user interface for establishing rooms associated with spatial divisions in a construction project, in accordance with one embodiment of the present invention.

FIG. 9 is an exemplary user interface used for scheduling inspections in a system and method for construction management, in accordance with one embodiment of the present invention.

FIG. 10A is a flow diagram illustrating a method for scheduling inspections and assigning inspectors, in accordance with one embodiment of the present invention.

FIG. 10B is an exemplary user interface used for scheduling inspections and assigning inspectors, in accordance with one embodiment of the present invention.

FIG. 11A is a flow diagram illustrating a method for providing results of completed inspections, in accordance with one embodiment of the present invention.

FIG. 11B is an exemplary user interface used for providing results of completed inspections, in accordance with one embodiment of the present invention.

### DETAILED DESCRIPTION OF THE PREFERRED EMBODIMENTS

Reference will now be made in detail to the preferred embodiments of the present invention, a method and system for construction management including the tracking of inspections. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for improved construction management, including improved methods and systems for tracking inspections in a construction project. Embodiments of the present invention provide for a reliable process of data collection. In addition, embodiments of the present invention provide for centralized data storage of inspection records. In other embodiments, holds, notices, or comments can be associated with an inspection. Action items may be triggered as a result of the holds, notices, or comments. In still other embodiments, reports can be generated on the rate of inspections completed, on inspections associated with a particular inspector, and on inspections or permits associated with a particular contractor. As a result, embodiments of the present invention reduce the risk of data loss, and provide the complex functionality needed to accurately track and report inspections on larger scale construction projects.

Embodiments of the present invention are directed to construction management. For purposes of brevity and clarity, throughout the specification, the tracking of inspections is provided as an example of the methods and systems for construction management. It is intended that examples illustrating the tracking of inspections in relation to embodiments of the present invention are also well suited to the tracking of other construction management related tools, such as those used in the permitting process, as implemented through embodiments of the present invention.

Notation and Nomenclature

Embodiments of the present invention can be implemented on software running on a computer system. The computer system can be a personal computer, notebook computer, server computer, mainframe, networked computer, handheld computer, personal digital assistant, workstation, and the like. This software program is operable for providing construction management tools, such as the tracking of inspections in a construction project. In one embodiment, the computer system includes a processor coupled to a bus and memory storage coupled to the bus. The memory storage can be volatile or non-volatile and can include removable storage media. The computer can also include a display, provision for data input and output, etc.

Embodiments of the present invention can be implemented through various network interfaces. For instance, in one embodiment, user interfaces are accessed through one or more web portals through the internet for purposes of construction management. In that manner, data access and storage can be centralized for increased data security and reliability. In other embodiments, embodiments of the present invention are implemented through various wireless network interfaces. In still other embodiments, construction management is achieved through a combination of wireless and connected interfaces.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “providing,” “calculating,” and “tracking,” “deleting,” “adding,” or the like, refer to the actions and processes of a computer system, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

Overview of Tracking Inspections in a Construction Project

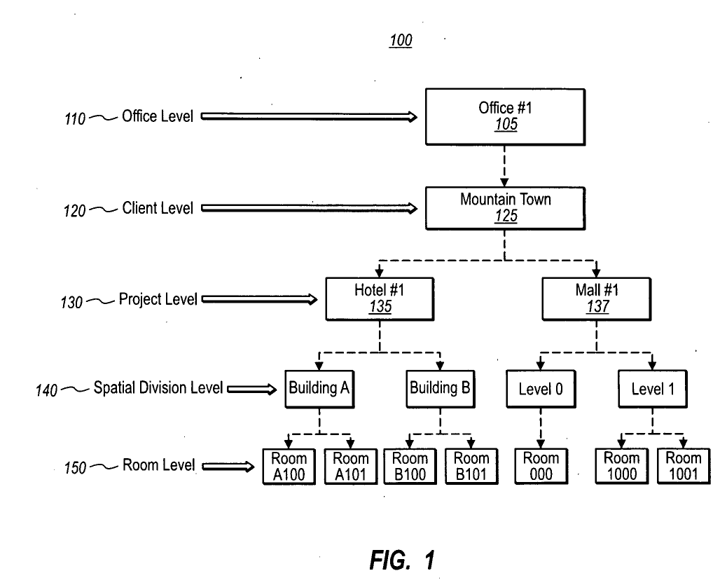

FIG. 1 is an illustration of the project breakdown 100 of multiple construction projects utilized in a system and method for inspection tracking, in accordance with one embodiment of the present invention. Each construction project can be broken into meaningful divisions. Inspections are tracked according to those divisions.

For example, in FIG. 1 five different levels are provided for partitioning out the management of construction projects. As shown, the five levels include an office level 110, a client level 120, project level 130, spatial division level 140 and a room level 150. While the present embodiment shows five levels used to manage multiple construction projects, other embodiments are well suited to reducing or adding the number of levels to manage multiple construction projects. The hierarchy of levels is dependent on the number of offices, clients, projects, etc. For instance, if there were only one office of concern, then office level 110 could be removed.

As shown in FIG. 1, the highest level is the office level 110. For instance, Office #1 is listed in block 105. Other offices could be listed at office level 110 that would manage the inspection process for other construction projects. Designation of offices could be based on geography, particular clients handled, or any other criteria.

The client level 120 is shown below the office level 110. Management of the inspection process is handled on a client by client basis, in this embodiment. For instance, the government entity of Mountain Town as shown in block 125 is a client of Office #1, and is handling multiple construction projects. For these projects, Mountain Town requires certain inspections to be performed to ensure the proper completion of those construction projects. In this hierarchy, a relational hierarchy is established between the inspections handled and required by Mountain Town, and each of the various levels shown in FIG. 1.

Project level 130, spatial division level 140, and room level 150 break down individual construction projects into meaningful spatial divisions. Inspections can be tracked according to those divisions, in accordance with one embodiment of the present invention. Management of the inspection process can be handled at various levels of the hierarchy shown in FIG. 1. In addition, management of inspections can be handled at each of the levels (e.g., office level 110, client level 120, or the project level 130). As such, embodiments of the present invention are able to manage the inspection process for each of those construction projects with greater ease, speed, and accuracy when compared to traditional inspection tracking techniques.

At the project level 130, two construction projects are shown that are associated or come within the jurisdiction of Mountain Town. The construction projects include the Hotel #1 in block 135, and Mall #1 in block 137. As such, a hotel and a mall are being built within the jurisdiction of Mountain Town.

At the spatial division level 140, the individual construction projects are further broken down into various divisions. These typically are grouped according to spatial relationships. That is, each spatial division gives a description to that area of the construction project. Completion of all spatial divisions in a construction project is necessary to finalize completion of the project. Some examples of divisions are as follows: building, floor, level, wing, etc. As shown in FIG. 1, Hotel #1 is broken down in two divisions: Building A and Building B. Also, Mall #1 is broken down into two divisions: Level 0 and Level 1.

In addition, at the room level 150, the various construction projects are further broken down by room numbers. Rooms are assigned to different spatial divisions. Room numbers can be assigned by the numbers that are present on the building plans, or some other reference document. In this way, the contractor, permit technician, inspector, and any other concerned party has a consistent reference point when referring to a project, and the management of the inspection process.

For example, in Hotel #1, Room A100 and Room A101 are assigned to the spatial division of Building A. In addition, Room B100 and Room B101 are assigned to the spatial division of Building B. For Mall #1, Room 000 is assigned to Level 0, and Rooms 1000 and 1001 are assigned to Level 1.

Inspection tracking can be done at each of the levels of FIG. 1, or any variation of groupings or divisions within the hierarchy of FIG. 1, in accordance with embodiments of the present invention. For instance, inspections can be tracked at each individual room or groups of rooms in a spatial division (e.g., Rooms A100 and A101) or across spatial divisions (Rooms A101 and B100), by spatial division or groups of spatial divisions, by construction project or groups of construction projects, by client or groups of clients, by office or groups of offices, etc.

In accordance with another embodiment of the present invention, the permit process can be integrated within the hierarchy sown in FIG. 1 used for tracking inspections. For instance, a permit level (not shown) can be placed below the project level 135, or below the spatial division level 140, or below any other suitable level. In this way, cross-referencing is possible between inspections, permits, projects, contractors, inspectors, clients, offices, etc.

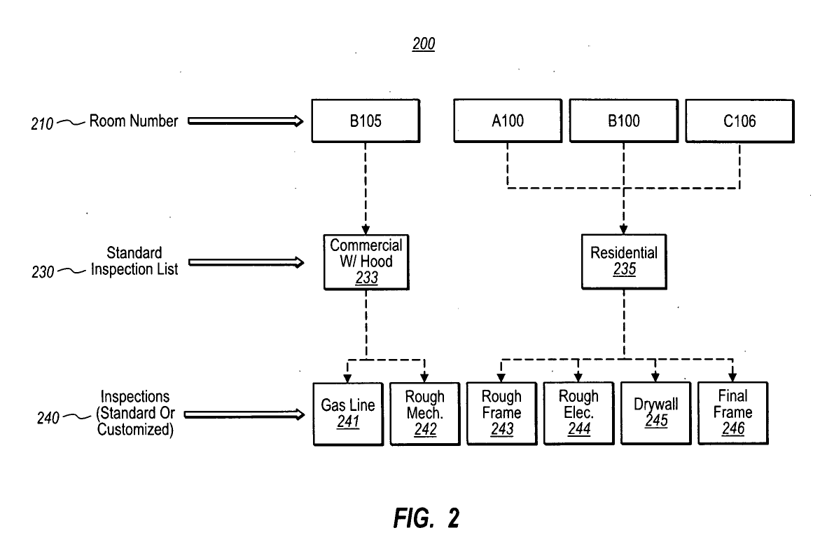

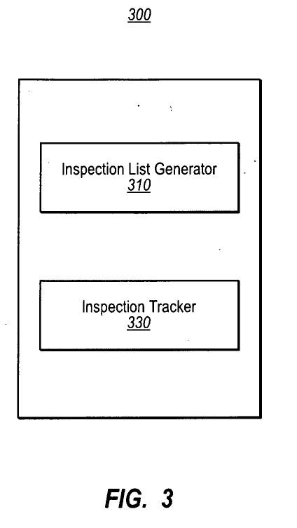

FIG. 2 is an illustration of the relationship between rooms and standard inspection lists, in accordance with one embodiment of the present invention. As will be described in further detail below in relation to FIGS. 3-5, associations between rooms and standard inspections lists are defined for use in tracking inspections across multiple construction projects. In this way, inspections for a particular construction project can quickly be identified by associating a particular room with a standard inspection list.

As shown in FIG. 2, approximately three general levels are used to associate inspections with a particular room number of a construction project, in accordance with one embodiment of the present invention. Assigning relationships between each of the levels will associate one or more inspections with a particular room. The different levels include a room number level 210, the standard inspection list level 230, and the inspections 240 associated with a particular room.

For example, room number level 210 lists the room numbers of interest for a particular construction project. The rooms may be of any type of suitable classification (e.g., bedroom, commercial kitchen, residential living, lounge, corridor). Room numbers may or may not correspond to the reference room numbers associated with a room upon completion of a construction project. For example a corridor would not be necessarily be assigned a room number upon completion of a project; but is assigned a room number for purposes of inspection tracking. In addition, a room may be assigned a first number for purposes of inspection tracking, but is assigned a different reference number upon completion of the construction project.

In addition, at the inspections level 240, inspections are listed for each corresponding room number. In particular, each standard inspection list shown at level 230 is associated with a group of one or more inspections. The standard inspection list can be universally applied across multiple construction projects, and as such, the group of inspections in each standard inspection list is also universally applied across multiple construction projects. In one embodiment, at level 240, the inspections associated with a corresponding room are the same as those listed with the corresponding standard inspection list. In another embodiment, at level 240 the inspections associated with a corresponding room are customized, and are based on the corresponding standard inspection list.

For example, as shown in FIG. 2, Room B105 is assigned the following standard inspection list: Commercial with Hood shown in block 233. Correspondingly, a group of inspections can be quickly generated for Room B105. That is, the Gas Line inspection, shown in block 241, and Rough Mechanical Inspection, shown in block 242, are associated with the Commercial with Hood standard inspection list, and are associated with Room B105.

As shown in FIG. 2, a particular standard inspection list (e.g., Residential in block 235) can be associated with one or more room classifications or types. This allows reuse of standard inspection lists, which reduces redundancy of creating list inspections. For instance, the inspections in residential standard inspection list, shown in block 235, can be performed on rooms of several classifications, such as residential living room, lounge, or bedroom. As an example, all associated rooms (e.g., Rooms A100, B100, and C106), at least initially are associated with the following inspections: Rough Frame in block 243, Rough Electric shown in block 244, Drywall shown in block 245, and Final Frame shown in block 246.

System and Method for Tracking Inspections in a Construction Project

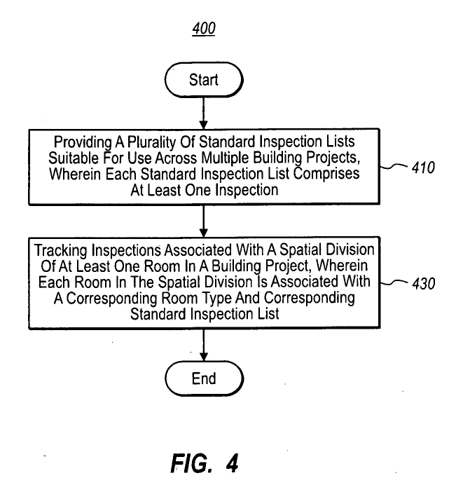

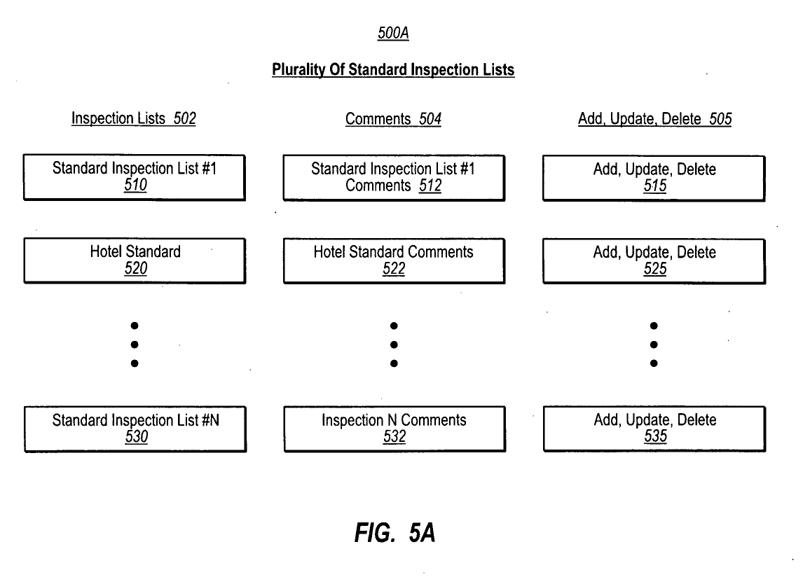

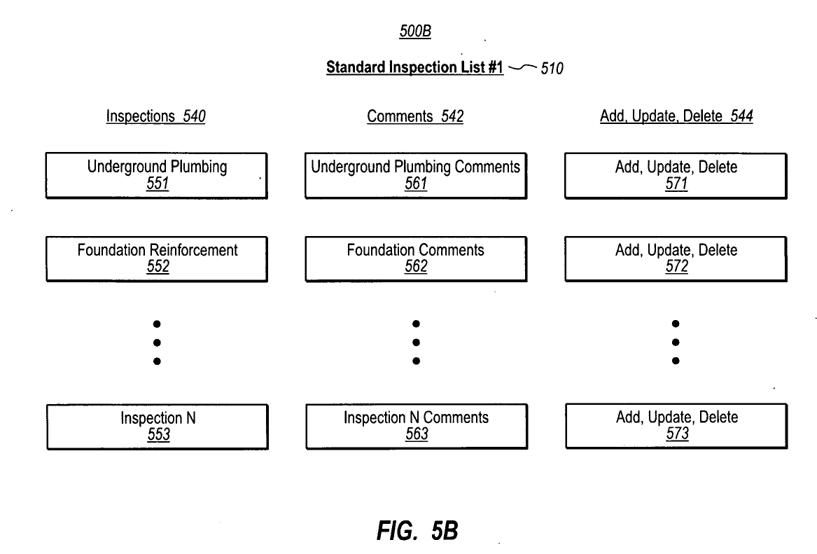

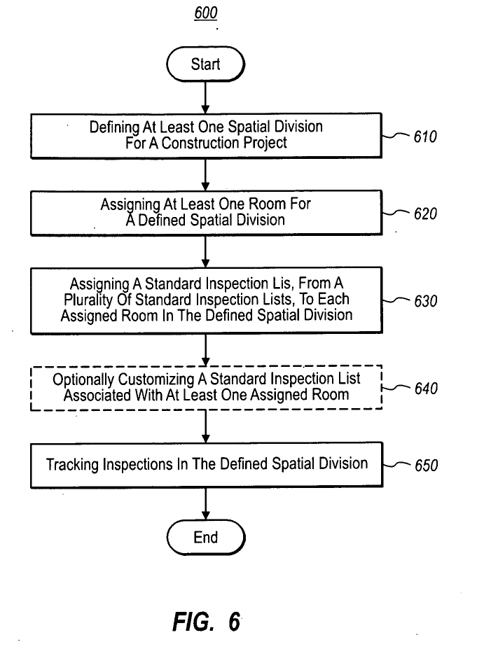

FIGS. 3, 4 and 6 in combination with FIGS. 1, 2, 5A, and 5B illustrate a process for inspection tracking in a construction project, in accordance with embodiments of the present invention. In particular, FIG. 3 is a system for construction management to include inspection tracking. FIGS. 4 and 6 are flow diagrams illustrating methods for construction management, and in particular inspection tracking that can be implemented by the system of FIG. 3. The FIGS. 5A and 5B illustrate various tools for implementing the construction management to include inspection tracking as described in FIGS. 4 and 6.

More specifically, FIGS. 3 and 4 in combination illustrate a method of construction management and a system for implementing the same, in accordance with embodiments of the present invention. FIG. 3 is a block diagram of a construction management system 300 for inspection tracking, in accordance with one embodiment of the present invention. The construction management system 300 implements the method of FIG. 4, in one embodiment, wherein FIG. 4 illustrates a flow diagram 400 implementing a method of construction management, and in particular, a method for inspection tracking.

Turning now to FIG. 3, construction management system 300 is used to track and record results for inspections. The construction management system 300 includes an inspection list generator 310 and an inspection tracker 330. As described previously, tracking of inspections can be accomplished over divisions in the project, such as by the overall construction project, within spatial divisions of the project (e.g., wings, floors, levels, etc.), groups of rooms, or at the room level, in one embodiment.

The inspection list generator 310 provides a plurality of standard inspection lists suitable for use across multiple construction projects. At least one standard inspection list includes at least one inspection. In one embodiment, the inspection list generator 310 implements 410 of flow diagram 400 by providing the plurality of standard inspection lists. Generally, each of the standard inspection lists includes a default group of inspections. As such, the default group of inspections defines the corresponding standard inspection list. This default group of inspections are to be performed, absent any customization, on any room that is associated with the corresponding standard inspection list. In this manner, a group of inspections can be quickly assigned to a room just by associating that room with a standard inspection list, in one embodiment. Customization of the group of inspections in the standard inspection list is also implemented in another embodiment.

Standard inspection lists are created according to the type of inspections needed to complete a portion of a construction project. For example, in one embodiment, an inspection list is created generally to include those inspections necessary to be performed for one or more room classifications. For example, a standard inspection list entitled “Commercial” would contain all of the inspections typically associated with a commercial construction project. The default group of inspections in the Commercial standard inspection list could include in part the following inspections: Above Ceiling Electrical, Above Ceiling Frame, Above Ceiling Mechanical, Above Ceiling Plumbing, Damper Final, Damper Rough, Drop Frame, Final Building, Final Electric, Final Mechanical, Final Plumbing, Fireplace Final, Fireplace Rough, First Layer Drywall, Gas Test, etc.

FIGS. 5A and 5B are illustrations of exemplary user interfaces for setting up and creating standard inspection lists utilized within the system and method of construction management, including tracking inspections, in accordance with embodiments of the present invention. In one embodiment, the standard inspection lists is created before any tracking is implemented. The standard inspection lists are suitable for use across multiple construction projects, and once established are not typically changed, in one embodiment. In another embodiment, the standard inspections lists can be edited at a later period in time.

For example, FIG. 5A discloses a user interface 500A that illustrates the creation of a plurality of standard inspection lists, in accordance with one embodiment of the present invention. In a particular embodiment, at least one of the standard inspection lists can be applied to rooms across multiple construction projects. In that way, groups of inspections need not be created for every room, especially when there is some overlap as to identity between rooms, such as when a particular construction project has many approximately identical rooms (e.g., hotel sleeping rooms), or when different construction projects include similar rooms (e.g., bathrooms, or kitchens).

As shown, the column disclosing the inspection lists 502 includes multiple standard inspection lists, including Standard Inspection Lists #1 through #N (shown in blocks 510 and 530). An example of a standard inspection list is Hotel Standard in block 520, and includes all of the inspections typically performed for a hotel project. A previous example of a standard inspection list is Commercial. For each of the standard inspection lists, the comments column 504 allows for comments to be entered. For instance, block 512 provides comments to Standard Inspection List #1, block 522 provides comments to Hotel Standard in block 520, and block 532 provides comments to Standard Inspection List #N.

In addition, the add/update/delete column 505 allows for the adding and deletion of standard inspection lists, and the updating of a corresponding inspection list. For instance, additional standard inspection lists can be created by using any add/update/delete button (e.g., 515, 525, or 535). Also, a standard inspection list can be deleted from the plurality of standard inspection lists. For instance block 515 can be used to delete Standard Inspection List #1. In addition, a standard inspection list can be updated. For instance block 515 can be used to update inspections found in the Standard Inspection List #1, block 525 can be used to update inspections found in the Hotel Standard inspection list, and block 535 can be used to update inspections found in the Standard Inspection List #N.

FIG. 5B discloses an exemplary user interface 500B that illustrates the creation of Standard Inspection List #1 510 from the plurality of standard inspection lists shown in FIG. 5A, in accordance with one embodiment of the present invention. The Standard Inspection List #1 510 is shown for purposes of illustration and is representative of the creation or definition of any standard inspection list in the plurality of standard inspection lists shown in FIG. 5A. In one embodiment, the group of inspections in the exemplary Standard Inspection List #1 510 includes at least all of the inspections that should be completed for that type of room. In that way, customization of a standard inspection list to a particular room would only entail the deletion of inspections from Standard inspection List #1 510.

In another embodiment, the group of inspections in the exemplary Standard Inspection List #1 510 includes a subset of inspections that should be completed for that type of room. Customization of a standard inspection list to a particular room would entail the addition of inspections from a plurality of available inspections selectable for each of the plurality of standard inspection lists shown in FIG. 5A, and possibly the deletion of inspections from the standard inspection list. For example, a bathroom for a mall may need a handicapped accessibility inspection, which is added to the standard inspection list from a plurality of available inspections. In still another embodiment, a newly created inspection is added to the Standard Inspection List #1 510 to create a customized standard inspection list.

The Standard Inspection List #1 510 includes at least one inspection, in one embodiment. For example, as shown in FIG. 5B, multiple inspections are included in the inspections column 540, for example: underground plumbing in block 551, foundation reinforcement in block 552, on up to inspection #N in block 553. The inspections included in the Standard Inspection List #1 510 as shown in FIG. 5B are before any customization has occurred. As such, Standard Inspection List #1 510 is generally applicable to various room classifications or types across multiple construction projects, in accordance with one embodiment of the present invention. This reduces the number of standard inspection lists that need to be created.

In addition, the add/update/delete column 542 allows for the adding and deletion of standard inspection lists, and the updating of a corresponding inspection list. For instance, additional inspections can be added to the Standard Inspection List #1 510 by using any add/update/delete button in the add/update/delete column 544 (e.g., 571, 572, and 573). Also, an inspection list can be deleted or updated from the Standard Inspection List #1 510. For instance block 571 can be used to delete or update the underground plumbing inspection. Similarly, block 572 can be used to delete or update the foundation reinforcement inspection, and block 573 can be used to delete inspection N.

Additionally, for each of the inspections in Standard Inspection List #1 510, the comments column 542 allows for comments to be entered. For instance, block 561 allows for or provides comments to the underground plumbing inspection, block 562 allows for or provides comments to the foundation reinforcement inspection, and block 563 allows for or provides comments to inspection N.

Returning back to FIG. 3, the tracker 330 tracks inspections associated with a spatial division in a construction project. At least one room in the spatial division is associated with a corresponding standard inspection list, in one embodiment. More particularly, in another embodiment, each of the rooms in the spatial division is associated with a corresponding standard inspection list. In this manner, a corresponding standard list of inspections can be assigned to each of the rooms in that spatial division. Thereafter, the group of inspections, in a corresponding standard list of inspections that is associated with a room in a spatial division, can be customized. Tracking of the status of completion of the inspections for a spatial division is then achieved.

In one embodiment, the tracker 330 tracks a customized list of inspections for a room in a spatial division. In particular, the customized list of inspections is based on a corresponding standard inspection list for that room in the spatial division. As described previously, the standard inspection list can be customized through the addition and deletion of inspections.

In one embodiment, tracker 330 tracks inspections in a division of a construction project. That is, inspections can be tracked according to any defined spatial division. For example, a division may include a portion of a room, a single room, groups of rooms, a defined spatial division (e.g., wing, floor, level, building, etc.) of a construction project that includes at least one room, by construction project, by client, etc. In addition, inspections can be tracked across different defined spatial divisions. For instance, inspections for multiple rooms associated with different and defined spatial divisions can be tracked (e.g., room #1 on floor 1 and room #10 on floor 10). In another embodiment, inspections can be tracked according to individual inspectors. As such, a report can be generated on the status of inspections to be performed on individual inspectors.

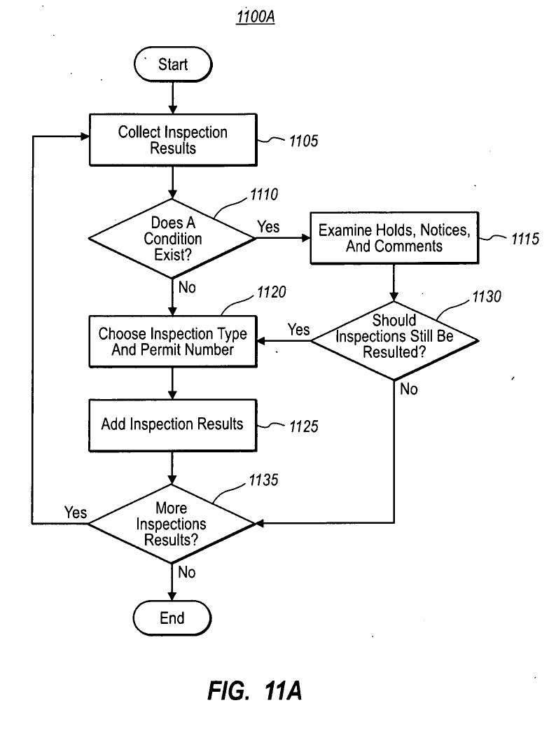

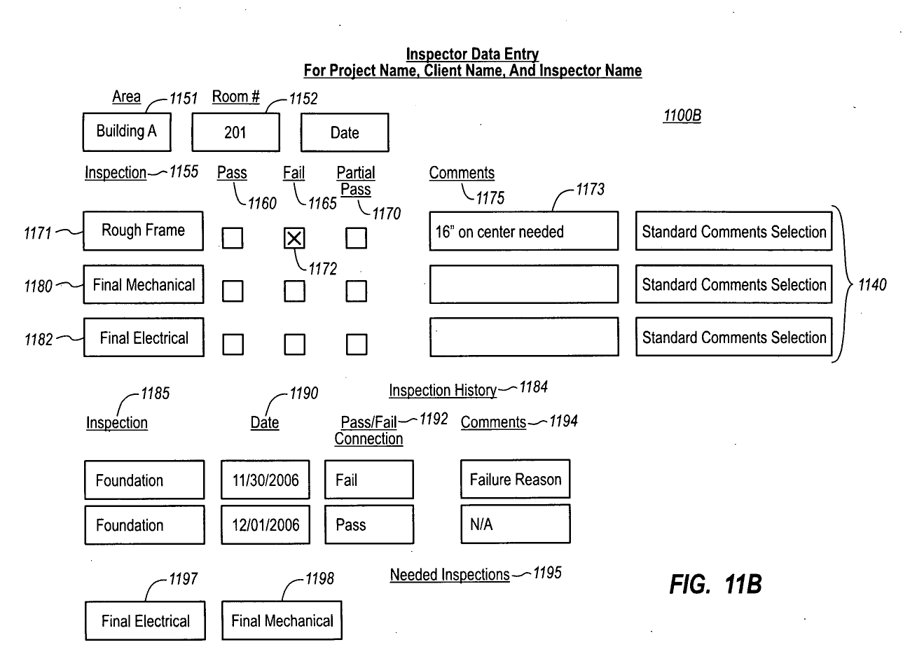

In one embodiment, tracker 330 tracks inspections by calculating a percentage of completion for the concerned division of a construction project (e.g., room, defined spatial division, etc.). In one embodiment, inspection tracking is accomplished automatically. The inspections for a particular division (e.g., grouping of rooms) is given a response when performing an inspection, such as pass, partial pass, or fail. Further description of the inspection performance is discussed in FIG. 11B. In one embodiment, successful completion of an inspection is defined as a pass.

To track inspections, tracker 330 calculates a percentage of completion of inspections associated with a grouping of rooms of a defined spatial division between a number of inspections successfully completed and a total number of inspections associated with the grouping of rooms, in one embodiment. In particular, tracker 330 determines how many inspections have passed in relation to the total number of inspections associated with the grouping of rooms to determine a percentage of completion.

FIG. 6 is a flow diagram 600 illustrating a method for construction management, in accordance with one embodiment of the present invention. The method outlined in FIG. 6 is performed on a particular construction project, in one embodiment. That is, once the plurality of standard inspection lists is defined, and the relationships between rooms in a construction project and the plurality of standard inspection lists are defined, the method of FIG. 6 is implemented in order to track inspections associated with the particular construction project. The plurality of standard inspection lists is defined such that it is suitable for use across multiple room classifications and across multiple construction projects. The method of flow diagram 600 can be implemented by the tracker 330 of FIG. 3, in one embodiment.

At 610, at least one spatial division is defined for a construction project. As previously defined, a spatial division compartmentalizes the construction project into manageable pieces. For example, a spatial division may be compartmentalized into a part of a room, room, wing, floor, level, or building, or any grouping of rooms, etc.

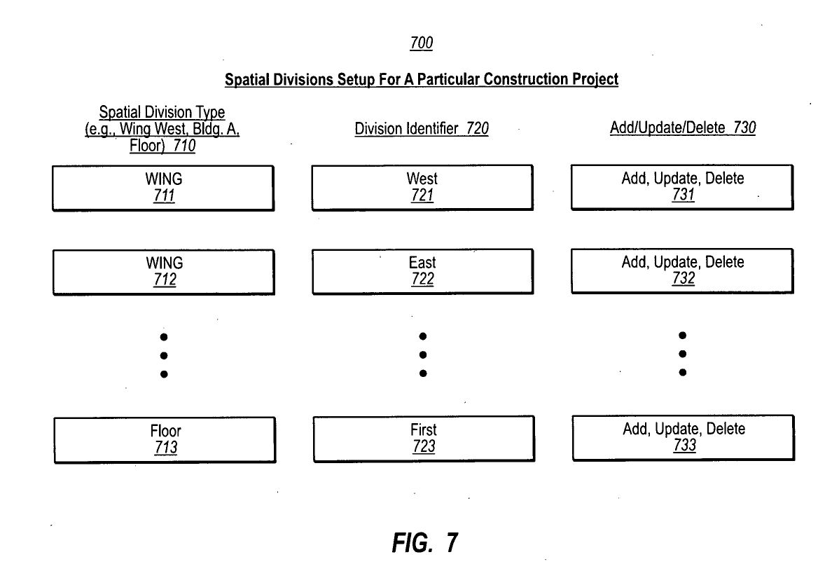

For example, FIG. 7 illustrates an exemplary user interface 700 that discloses the compartmentalization of a particular construction project, that is typically associated with a particular client. User interface 700 is used to define a plurality of spatial divisions for the construction project, wherein each spatial division gives some kind of description to that area of the project. Typically, spatial divisions are compartmentalized into manageable divisions. For example, as previously defined, spatial divisions can be a portion of a room, a room, a group of rooms, a wing, a level, a building, a floor, etc.

As shown, column 710 discloses the defined spatial divisions for a particular construction project, including two wings in blocks 711 and 712, and a floor defined in block 713. A construction project may be compartmentalized into one or more defined spatial divisions.

Column 720 discloses the division identifier to distinguish between similar spatial divisions. For instance, in block 721, the wing defined in block 711 is further identified as the West Wing by the identifier in block 721. As such, the West Wing is separate from the East Wing as identified by blocks 722 and 712. In addition, block 713 in combination with block 723 define the First Floor.

In addition, the add/update/delete column 730 allows for the adding, updating and deletion of spatial divisions and/or division identifiers. For instance, additional spatial divisions can be created by using any add/update/delete button (e.g., 731, 732, or 733). Also, a spatial division can be deleted. For instance block 731 can be used to delete the West Wing, block 732 can be used to delete the East Wing, and block 733 can be used to delete the First Floor. In addition, any of the spatial divisions can be updated using the corresponding add/update/delete buttons.

Returning back to FIG. 6, at 620, at least one room is assigned for a defined spatial division. That is, in one embodiment, at least one spatial division includes at least one room. More particularly, in another embodiment, a construction project is divided up into one or more spatial divisions, wherein each of the spatial divisions includes or is assigned at least one room.

At 630, a standard inspection list is assigned for each assigned room in the defined spatial division. As such, each of the rooms is automatically associated with a group of inspections to be performed. In one embodiment, the standard inspection list is taken from a plurality of standard inspection lists. Of course, in another embodiment, the standard inspection list may be the only list available for selection, in that each assigned standard inspection list may be later modified according to the needs of the corresponding room.

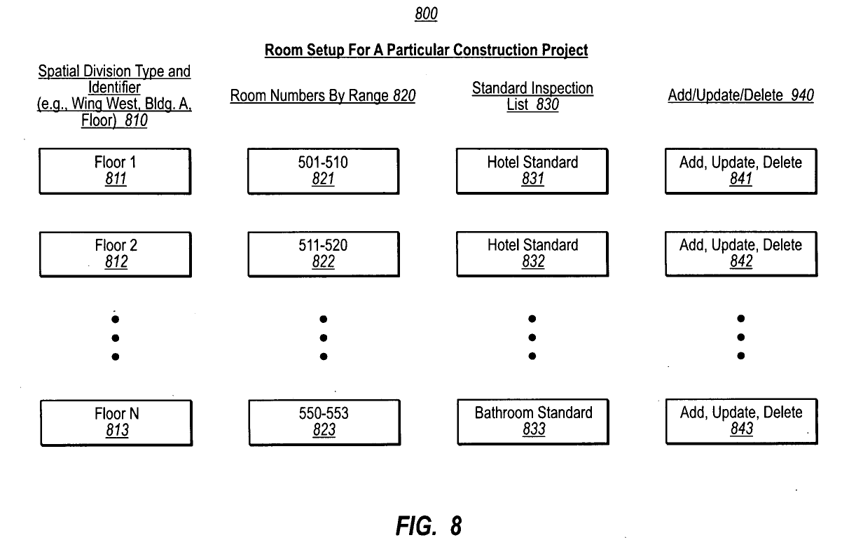

FIG. 8 discloses an exemplary user interface 800 that illustrates the creation of rooms for corresponding spatial divisions in a particular construction project that is typically associated with a particular client, in accordance with one embodiment of the present invention. In addition, user interface 800 defines the association between rooms in a spatial division and their corresponding standard inspection list.

As shown, column 810 discloses the spatial divisions, column 820 discloses the room numbers by range, and column 830 discloses the associated standard inspection list. An association between spatial division, room, and standard inspection list is achieved in each row. For instance, blocks 811, 821, and 831 in the top row discloses that rooms 501-510 are associated with the spatial division of Floor 1. In one embodiment, the rooms are defined or arranged by a range of consecutive numbers. In other embodiment, the rooms are defined or arranged by user defined numbers. In addition, each of the rooms 501-510 are assigned to a standard inspection list called “Hotel Standard,” as defined in block 831 This inspection list can be used for performing inspections on sleeping rooms typical for hotels. Without further customization, the inspections in the “Hotel Standard” inspection list are to be performed on rooms 501-510.

Similarly, blocks 812, 822, and 832 discloses that rooms 511-520 are associated with the spatial division of Floor 2. Each of the rooms 511-520 are also assigned to the “Hotel Standard” inspection list. Without further customization, the inspections in the “Hotel Standard” inspection list are to be performed on rooms 511-520.

Also, blocks 813, 823, and 833 are associated with the spatial division of Floor N. Each of the rooms 550-553 are assigned to a “Bathroom Standard” inspection list. This inspection list can be used for performing inspections on bathrooms in various construction projects (e.g., residential, commercial, etc.). Without further customization, the inspections in the “Bathroom Standard” inspection list are to be performed on rooms 550-553.

Further, a description of the rooms is provided, in another embodiment. For instance, though not shown in FIG. 8, a text field is provided for a user to enter a description of corresponding rooms. For instance, a description for rooms 501-510 may indicate those rooms are standard hotel rooms to include an open space for a bed and living area.

Returning back to FIG. 6, at 640 a standard inspection list is optionally customized. In particular, a standard inspection list associated with at least one assigned room in the spatial division is customized. As discussed previously, customization of a inspections for application to a particular room entails adding or deleting inspections to or from the corresponding standard inspection list. The addition of inspections can be from a plurality of available inspections, or can be a newly created inspection particular to that room.

At 650, inspections in the defined spatial division are tracked. For instance, as discussed previously, the present embodiment calculates a percentage of completion of inspections associated with a defined spatial division between a number of inspections successfully completed and a total number of inspections associated with the spatial division. In particular, the present embodiment determines how many inspections have passed in relation to the total number of inspections associated with the grouping of rooms to determine a percentage of completion, in one embodiment.

Generating Reports Related to Inspection Tracking

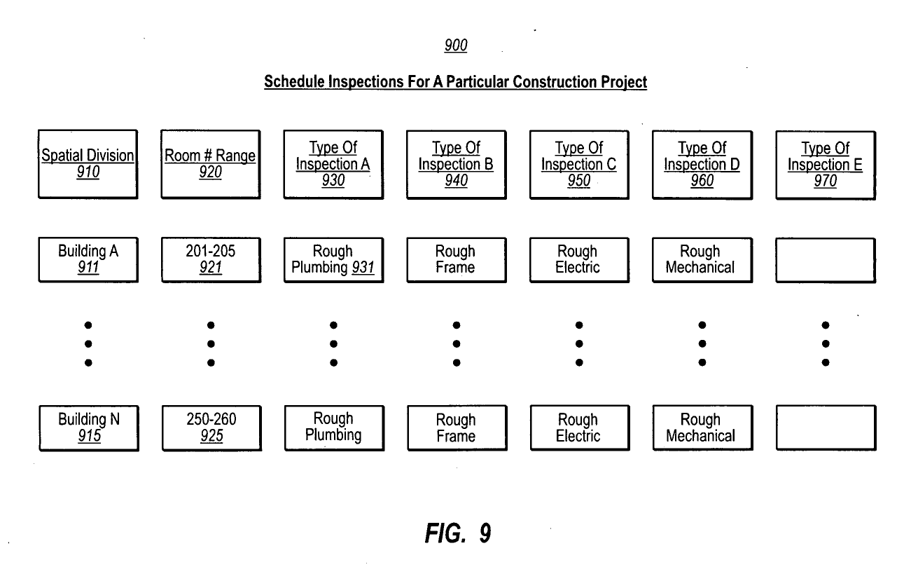

FIG. 9 illustrates an exemplary user interface 900 that is used for scheduling inspections, in accordance with one embodiment of the present invention. The user interface 900 is shown for purposes of illustration only, and can be implemented through various other means, to include other forms of user interfaces. In one embodiment, the scheduling of inspections is accomplished according to the associated client, construction project, spatial division, and assigned room in the corresponding spatial division.

Columns 910 and 920 disclose the relationship between a spatial division and a set of rooms, denoted by range, in one embodiment. For instance, in the top row, Bldg. A defined in block 911 is associated with Rooms 201-205, defined in block 921. The associated inspections to be performed are listed in the corresponding blocks in the following columns 930, 940, 950, 960, and 970, and are shown for purposes of illustration only. Any number of inspections may be in association with the Rooms 201-205. That is, the number of inspections may vary between zero to N.

In addition, the group of inspections are based on the corresponding standard inspection list assigned to Rooms 201-205 as previously defined, for example, in the room setup of FIG. 8. That is, the group of inspections in FIG. 9 associated with Rooms 201-205 may be a customized list, or may be similar to the corresponding standard inspection list. In particular, as shown in FIG. 9, the inspections to be performed on Rooms 201-205 are, as follows: rough plumbing, rough frame, rough electric, and rough mechanical.

Similarly, in the bottom row, Bldg. N defined in block 915 is associated with Rooms 250-260, defined in block 925. The associated inspections to be performed on Rooms 250-260 are listed in columns 930, 940, 950, 960 and 970, and include rough plumbing, rough frame, rough electric, and rough mechanical.

In one application, the user interface 900 is implemented (e.g., by a contractor) once a portion of the construction project has been completed, and is ready for inspection. As such, user interface 900 is used to select or activate those inspections that are ready to be performed. In one embodiment, the process for scheduling an inspection for an inspection is achieved by selecting the corresponding block. For example, to schedule the rough plumbing inspection of Rooms 201-205, block 931 is selected. In that way, the rough plumbing inspection is activated, and ready for inspection.

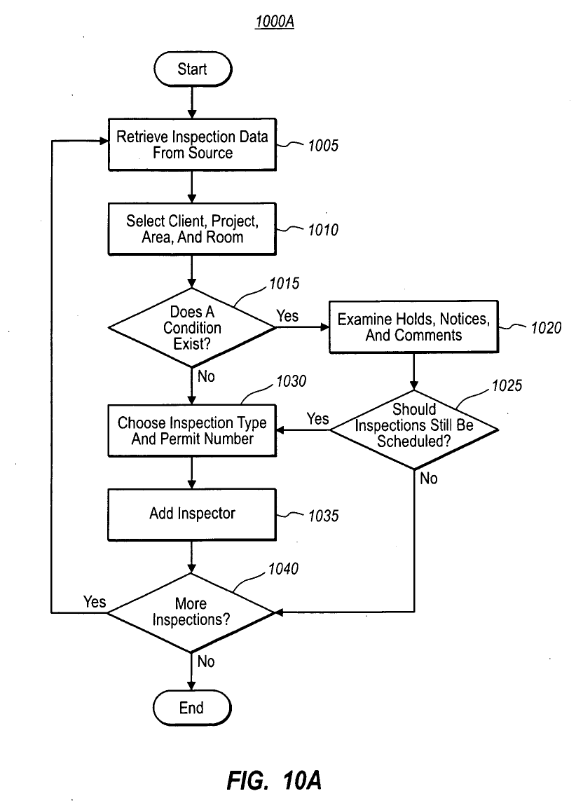

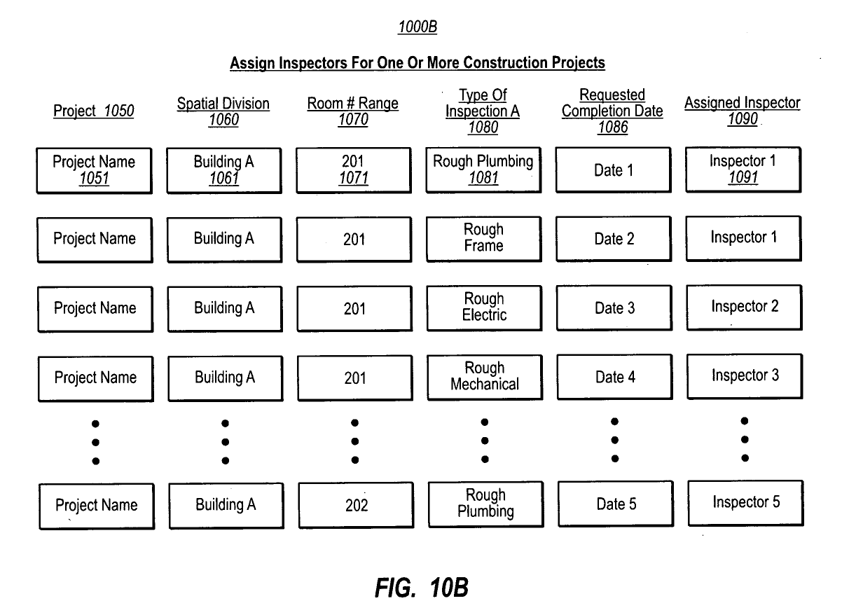

FIGS. 10A and 10B in conjunction illustrate a method of activating and scheduling inspections, in accordance with embodiments of the present invention. In particular, FIG. 10A is a flow diagram illustrating a method of scheduling inspections, and FIG. 10B illustrates an exemplary user interface for assigning inspectors to those inspections that have been activated and ready for inspection.

In particular, the method of FIG. 10A is implemented when inspections are ready to be scheduled. For instance, the entity responsible for scheduling inspections uses interface 1000B of FIG. 10B to schedule inspections for a particular construction project. The method is accomplished automatically, in one embodiment. At 1005, inspection data is retrieved from the source. That is, the various relationships between the clients, construction projects, standard inspection lists, room types, defined spatial divisions, and rooms are accessed or retrieved.

In one embodiment, inspections can be assigned in batch by room, or spatial division. In another embodiment, inspections can be assigned individually, on an inspection by inspection basis. As such, embodiments of the present invention allow for the scheduling of inspections for multiple rooms at the same time.

At 1010, a particular client, construction project, area or spatial division, and room is selected in order to schedule an inspection for that room. Because of the relationships between each of the described levels, the group of inspections associated with that room is defined, and from FIG. 9, those inspections that are ready and activated can be scheduled for performance by an inspector.

At 1015, the present embodiment determines if a condition exists for a particular room. These conditions may dictate whether an inspection for that room can be scheduled. The conditions may be implemented through a hold/notice/comment. In one embodiment, all holds/notices/comments are viewed before the scheduling of corresponding inspections occurs. A hold/notice/comment may be placed on various levels, such as by project, spatial division, room, or permit identifier (ID), etc. For instance, a hold may be placed on an inspection, or on a room in the spatial division. As an example, the underground plumbing rough-ins in Rooms 008, 009, 010 missed the walls. As a solution, the plumbing contractor is tasked to break out the floor, cut pipes, and move the plumbing rough-ins. As a result, all underground plumbing must be re-inspected. As such, further performance of inspections cannot be performed until the hold/notice/comment is cleared.

A distinction between the hold, notice, and comments can be made. The hold places a permanent hold on the performance of inspections until the hold is cleared, in one embodiment. Comments may be used to further explain results from an inspection, or a hold on an inspection, etc, in one embodiment. Comments may be used to put a hold on an inspection. Notices also may be used to trigger a follow-up action, in one embodiment. For example, notices may indicate problems from an inspection that trigger a hold on the corresponding inspection. Additionally, notices may be used to trigger a follow-on inspection when a related inspection has been completed, or a partial inspection has been completed. For example, plumbing for a bathtub may need to be inspected before the walls are put into place. As such, a partial inspection is performed and must be in compliance before the remaining inspections for that room can be scheduled. A notice or hold, or comment may be used to trigger this condition. If a condition exists, then 1020 is performed; however, if a condition does not exist, then 1030 is performed.

At 1020, the holds, notices and comments are examined to determine if any action should be taken if a condition exists. For example, a hold may be in place, or a follow on inspection may be conditioned on successful performance of a different inspection.

At 1025, the present embodiment determines if inspections should be scheduled after examining the holds, notices, and comments. If inspections are to be scheduled, then 1030 is performed, otherwise, 1040 is performed.

At 1030, to schedule an inspection, the inspection type and permit number are selected. That is, the group of inspections to be scheduled is selected and chosen, for example through user interface 900 of FIG. 9.

At 1035, an inspector is assigned to the group of inspections previously selected for scheduling at 1030. As such, embodiments of the present invention are able to select and assign individual inspectors to perform selected inspections, or group of inspections. In that way, inspections can be cross-referenced back to inspectors, permits, construction projects, room numbers, spatial divisions, clients, etc. As such, information related to inspections can be readily determined for a particular room number in a construction project, by the location or reference number of the room in a construction project, in one embodiment.

At 1040, the present embodiment determines if more inspections are to be scheduled. These further inspections can be from the same room, or a different room, the same spatial division, or a different spatial division. If there are more inspections to be scheduled, 1005 is performed, otherwise the method of FIG. 10A ends.

FIG. 10B discloses an exemplary user interface that illustrates the assignment of inspectors in order to schedule one or more inspections, in accordance with one embodiment of the present invention. The assignment of inspectors can be accomplished by inspections, groups of inspections, rooms, groups of rooms, or any other required spatial division. In the present embodiment shown in FIG. 10B, inspectors are assigned to individual inspections.

As shown, the inspections are identified through construction project, spatial division, room number, and type of inspection in columns 1050, 1060, 1070, 1080, 1085, and 1090, respectively. For example, from FIG. 9, the rough plumbing, rough frame, rough electric, and rough mechanical inspections have been activated and ready for scheduling for Room 201, in Bldg. A. The user interface 1000B can be used to assign inspectors and schedule the inspections associated with Room 201.

For instance, blocks 1051, 1061, 1071, and 1081 provide a relationship between the construction project, spatial division, room and inspection. Specifically, the rough plumbing inspection needs to be scheduled for Room 201 that is in Bldg. A of the corresponding construction project. In block 1091, an inspector is assigned to perform the rough pluming inspection. The inspector is selected from a group of inspectors authorized to perform the inspection, in one embodiment. As shown, Inspector 1 has been assigned to perform the rough plumbing inspection. Similarly, Inspector 1 has been assigned to perform the rough frame inspection for the same Room 201 in Bldg. A.

As shown in FIG. 10B, any number of inspectors can be assigned to perform inspections in one room. For instance, Inspector 2 has been assigned to perform the rough electric inspection, and Inspector 3 has been assigned to perform the rough mechanical in Room 201 in Bldg. A. As such three different inspectors have been selected to perform inspection for Room 201 in Bldg. A.

In addition, the user interface 1000B can be used to schedule any number of inspections for rooms or groups of rooms to include, multiple rooms, spatial divisions, construction project, etc. For example, as shown in FIG. 10B, Inspector 5 has been assigned to perform the rough plumbing inspection for Room 202 in Bldg. A.

In addition, column 1085 provides a requested completion date for each of the inspections that have been scheduled, in one embodiment. In that way, the assigned inspector has a target date by which to complete the inspection.

FIGS. 11A and 11B in conjunction illustrate a method of providing results for inspections that have been performed, in accordance with one embodiment of the present invention. In particular, FIG. 11A is a flow diagram illustrating a method of providing results of inspection, and FIG. 11B illustrates an exemplary user interface for providing the results of inspections.

In particular, the method of FIG. 11A is implemented when an inspector has completed an inspection and those results are ready to be entered for purposes of inspection tracking. For instance, the entity responsible for data entry uses interface 1100B of FIG. 11B to enter in results of inspections. At 1105, inspection data is retrieved from the source. That is, the various relationships between the clients, construction projects, standard inspection lists, room types, defined spatial divisions, and rooms are accessed or retrieved.

A particular client, construction project, area or spatial division, and room is selected in order to provide inspection results. Because of the relationships between each of the described levels, the group of inspections associated with that room is defined, and from FIG. 9, those inspections that have been scheduled and performed are available for entry of results.

At 1110, the present embodiment determines if a condition exists for a particular room. These conditions may dictate whether results for an for a particular room are valid. The conditions may be implemented through a hold/notice/comment. In one embodiment, all holds/notices/comments are viewed before the entry of results. If a condition exists, then 1115 is performed, otherwise block 1120 is performed.

A hold/notice/comment may be placed on various levels, such as by project, spatial division, room, or permit identifier (ID), etc. For instance, a hold may be placed on an inspection, or on a room in the spatial division. As a result, until the hold has been removed, any inspection performed in the interim period is invalid and results from that inspection may also be invalid. As an example, the underground plumbing rough-ins in Rooms 008, 009, 010 missed the walls. As a solution, the plumbing contractor must break out the floor, cut pipes, and move the plumbing rough-ins. All underground plumbing must be re-inspected. Before any further inspection results can be entered with regards to those rooms, the holds must be lifted. As such, further performance of inspections and entry of those results are not permitted until the holds/notices/comments are cleared.

If a condition exists, at 1115, the holds, notices and comments are examined to determine if any action should be taken. For example, a hold may be in place, or a follow-on inspection may be conditioned on successful performance of a different inspection. Results cannot be entered until the hold/notice/comment has been successfully addressed.

At 1130, the present embodiment determines if results for inspections should be entered after examining the holds, notices, and comments. If inspection results are to be entered, then 1120 is performed, otherwise, 1135 is performed.

At 1120, to enter results, the inspection type and permit number are selected. That is, the inspection, or group of inspections that have results for entry, is selected and chosen, for example, through user interface 1100B of FIG. 11B.

At 1125, inspection results are entered for the corresponding inspection, or group of inspections. In the present embodiment, the results from inspections can be cross referenced back to individual inspectors, permits, construction projects, room numbers, spatial divisions, clients, etc. As such, information related the inspections, such as inspection results, can be readily determined for a particular room number in a construction project, by the location or reference number of the room, in one embodiment.

At 1135, the present embodiment determines if more inspection results are to be entered. These further inspections can be from the same room, or a different room, the same spatial division, or a different spatial division. If there are more inspection results to be entered 1105 is performed, otherwise, the method of FIG. 11A ends.

FIG. 11B discloses an exemplary user interface 1100B that illustrates the recording of the performance results of one or more inspections, in accordance with one embodiment of the present invention. As shown in user interface 1100B, the results are listed for a particular inspector and particular construction project. In other embodiment, results can be listed in any arrangement, such as across multiple inspectors, by group of rooms, spatial division, construction project, etc.

More particularly, blocks 1151 and 1152 indicate that a history of results for Room 201 in Bldg. A of the corresponding construction project is presented, in one embodiment. As shown, inspections and results and comments are identified in columns 1155, 1160, 1165, 1170, and 1175. For instance, results for the rough frame inspection as shown in block 1171 is provided in the pass column 1160, fail column 1165, or partial pass column 1170. Other performance criteria other than pass, fail, and partial pass may be used in any combination to determine inspection results, in accordance with other embodiments. As shown in block 1172, results indicate that the rough frame inspection failed. Comments have been provided as to the reason for the failure in block 1173, and indicate that 16 inches on center is needed.

In one embodiment, partial pass inspection results are provided in column 1170. Construction projects can require unique functionality that normally may not be utilized for inspections. For instance, a partial inspection may be performed so that a construction on a portion of a room may be completed and inspected before completing the rest of the room. Comments, holds, and notices may assist in achieving the proper result in a partial inspection.

In addition, rather than enter in comments, standard comments may be selected in blocks 1140, in accordance with one embodiment of the present invention. That is, a single failure for a particular inspection may occur frequently enough. That failure may be included in a list of selectable standard comments so that the failure need not be repeatedly entered each time the failure occurs.

In one embodiment, the inspection results are tied to a permit. That is, results can be cross referenced to a particular inspector, room, spatial division, construction project, or permit. This allows for additional reports to be generated for inspection results tied to a particular permit, for example.

As shown in FIG. 11B, a history of results 1184 is also provided. The history of results pertain to performed inspections associated with a room in the spatial division, in one embodiment. Column 1185 identifies a list of completed inspections for Room 201. For instance, the foundation inspection has been performed twice. The first time, the foundation inspection failed on Nov. 30, 2006, as is shown in results column 1192. The second time, the foundation inspection passed on Dec. 1, 2006. Comments may be provided as to particular inspections in column 1194.

As shown in FIG. 11B, a list of inspections 1195 needed to be performed is also provided. For instance, for Room 210, the final electrical and the final mechanical inspections still need to be performed. As such, from the results user interface 1100B, it can be deduced that four inspections need to be performed on Room 201, rough frame, final mechanical final electrical, and foundation. The foundation inspection has been performed and passed. The rough frame has failed, and the final electrical and final mechanical inspections are to be performed.

Exemplary user interfaces in FIGS. 5A, 5B, 7-9, 10B and 11B are shown for purposes of illustration only. Other embodiments are well suited to the display, editing, and reporting of information provided in the previously listed user interfaces, such as other forms of user interfaces used for the display, editing, and reporting of information.

Accordingly, embodiments of the present invention provide for tracking inspections in a construction project. Embodiments of the present invention provide for a reliable process of data collection. In addition, embodiments of the present invention provide for centralized data storage of inspection records. As a result, embodiments of the present invention reduce the risk of data loss, and provide the complex functionality needed to accurately track and report inspections on larger scale construction projects.

While the methods of embodiments illustrated in flow charts 4, 6, 10A, and 11A show specific sequences and quantity of operations, the present invention is suitable to alternative embodiments. For example, not all the operations provided for in the methods presented above are required for the present invention. Furthermore, additional operations can be added to the operations presented in the present embodiments. Likewise the sequences of operations can be modified depending upon the application.

A method and system for construction management including the process of tracking inspections, is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed:

1. A method for construction management, comprising:
providing a plurality of standard inspection lists suitable for use across multiple construction projects, wherein at least one standard inspection list comprises at least one inspection;
tracking inspections associated with a spatial division in a construction project, wherein at least one room in said spatial division is associated with a corresponding standard inspection list.

2. The method of claim 1, wherein said tracking inspections further comprises:
tracking a customized list of inspections based on a first corresponding standard inspection list for a first room in said spatial division.

3. The method of claim 2, further comprising:
deleting at least one inspection from said first corresponding standard inspection list to define said customized list.

4. The method of claim 2, further comprising:
adding an inspection to said first corresponding standard inspection list to define said customized list.

5. The method of claim 1, wherein said tracking inspections further comprises:
calculating a percentage of completion of inspections associated with a grouping of rooms of said spatial division between a number of inspections successfully completed and a total number of inspections associated with said grouping of rooms.

6. The method of claim 1, further comprising:
activating an inspection associated with said spatial division.

7. The method of claim 6, further comprising:
assigning an inspector to perform said inspection that is activated.

8. The method of claim 6, further comprising:
recording a performance of said inspection taken from a list comprising essentially of a pass, a partial pass, and a fail.

9. The method of claim 1, further comprising:
placing a hold on an inspection in said spatial division.

10. The method of claim 1, further comprising;
listing a notice on an inspection in said spatial division.

11. The method of claim 1, further comprising:
listing a comment on an inspection in said spatial division.

12. The method of claim 1, further comprising:
listing a history of results from performed inspections associated with a room in said spatial division;
identifying a list of completed inspections for said room; and
identifying a list of inspections needed to be performed for said room.

13. A method for construction management, comprising:
defining at least one spatial division for a construction project;
assigning at least one room for a defined spatial division;
assigning a standard inspection list, from a plurality of standard inspection lists, to each assigned room in said defined spatial division; and
tracking inspections in said defined spatial division.

14. The method of claim 13, further comprising:
defining said plurality of standard inspection lists for use across multiple construction projects, wherein at least one standard inspection list comprises at least one inspection.

15. The method of claim 13, further comprising:
creating a customized inspection list for an assigned room by deleting an inspection from a corresponding standard inspection list associated with said assigned room.

16. The method of claim 13, wherein said assigning at least one room comprises:
assigning a range of numbers for rooms in said spatial division.

17. The method of claim 13, wherein said tracking inspections comprises:
calculating a percentage of completion of inspections associated with a group of rooms in said spatial division between a number of inspections completed and a total number of inspections associated with said group of rooms.

18. The method of claim 13, further comprising:
activating an inspection for a first room in said spatial division; and
assigning an inspector to perform said inspection that is activated.

19. The method of claim 13, further comprising:
recording a performance of said inspection taken from a list comprising essentially of a pass, a partial pass, and a fail.

20. The method of claim 13, further comprising:
assigning a permit to an inspection in said defined spatial division.

21. The method of claim 13, further comprising:
placing a hold on an inspection of said spatial division.

22. A system for managing construction projects, comprising:
an inspection list generator providing a plurality of standard inspection lists suitable for use across multiple construction projects, wherein at least one standard inspection list comprises at least one inspection; and
a tracker for tracking inspections associated with a spatial division in a construction project, wherein at least one room in said spatial division is associated with a corresponding standard inspection list.
